(19) United States
(12) Patent Application Publication
(10) Pub. No.: US 2011/0129636 A1
(43) Pub. Date: Jun. 2, 2011

(54) Block Copolymer Containing a Photoactive Monomer Bearing a Photoisomerizable Group, Use Thereof in a 3D Optical Memory

(75) Inventors: Christophe Le Crom, Jurancon (FR); Sylvain Bourrigaud, Pau (FR); Sylvie Cazaumayou, Dax (FR)

(73) Assignee: Arkema France, Colombes (FR)

(21) Appl. No.: 12/995,025

(22) PCT Filed: May 15, 2009
(86) PCT No.: PCT/FR2009/050913

§ 371 Date: Feb. 10, 2011

(30) Foreign Application Priority Data
May 27, 2008 (FR) 0853429

(51) Int. Cl. B32B 3/02; C08F 220/10; C08L 33/08

(52) U.S. Cl. 428/65.1; 525/299; 525/94; 428/80

(57) ABSTRACT

The invention relates to a block copolymer comprising:
at least one soft block A with a T_{g} of between −55° C. and 0° C. and preferably between −40° C. and −1° C., and
at least one block B comprising at least one photoactive monomer bearing a photoisomerizable chromophore.

The photoactive monomer has the formula (I):

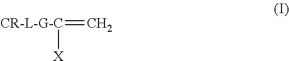

in which:
   X denotes H or CH₃—;
   G denotes —O—C(═O)—, —C(═O)—O—, a substituted or unsubstituted phenyl group, or —NR—C(═O)—, NR being linked to L and R being H or a C₁-C₁₀ alkyl group;
   L denotes a spacer group;
   CR denotes a photoisomerizable chromophore.

The block copolymer makes it possible to obtain a 3D optical memory. The invention also relates to this 3D optical memory.

### TECHNICAL FIELD

The considerable development of digital information systems has led to a growing need for large-capacity, compact data storage units that can preserve data for a long time, possibly exceeding 50 years. Optical storage is one of the technologies that is available for storing data (see in this respect SPIE “Conference on nano- and micro-optics for information systems” Aug. 4, 2003, paper 5225-16).

The technology that is envisioned in the present invention is more particularly that of 3-dimensional (3D) optical storage, as described in international patent applications WO 01/73779 and WO 03/070 689 and also in the Japanese Journal of Applied Physics, Vol. 45, No. 28, 2006, pp. 1229-1234. It is based on the use of a photoisomerizable chromophore that exists in two thermodynamically stable isomeric forms that are interconvertible under the effect of a light irradiation of suitable wavelength. When no data has yet been recorded, one of the two forms is predominant. For the writing of data, this isomeric form is made to convert into the other by light irradiation at a suitable wavelength. The conversion may result from a direct or indirect optical interaction (e.g. multiphotonic).

The present invention relates to a polymer that allows the 3D optical storage of data. It also relates to the material obtained from this polymer and to the 3D optical memory, especially in disk form.

### TECHNICAL PROBLEM

In patent application WO 03/070 689, the chromophores are attached to a polymer via the (co)polymerization of monomers bearing said chromophores. Patent application WO 2006/075 327 moreover teaches the advantage of increasing the chromophore concentration so as to improve the recording sensitivity of the optical memory. However, when the concentration of chromophore-bearing monomers increases, the mechanical properties of the polymer are affected and the material obtained is either too fragile or too soft to be able to be manipulated easily. There is thus a need to develop a rigid material that can be used in the field of 3D optical storage, which has good data readability and writability.

The Applicant has found that the block copolymers as defined in claim 1 or the mixture as defined in claims 25 to 27 satisfy this need.

### PRIOR ART

American patent U.S. Pat. No. 5,023,859 describes an optical memory based on the use of a polymer bearing a photosensitive group of stilbene, spiropyran, azobenzene, bisazobenzene, trisazobenzene or azoxybenzene type. The polymer may be a block polymer, but the exact nature of this block polymer is not specified.

International patent application WO 01/73779 describes an optical storage unit in which the information is stored by means of the cis/trans transition of a molecule (chromophore) containing a C═C double bond. The molecule may especially be a diarylalkylene of formula Ar₁R₁C═CR₂Ar₂ which may be bonded to a polymer.

International patent application WO 03/070 689 describes a polymer bearing a chromophore of diarylalkylene type. The polymer may be a poly(alkylacrylate) or a poly(alkylacrylate) copolymer, especially a copolymer with styrene. It may also be polymethyl methacrylate. It is not stated that it may be a block copolymer or that the chromophore is present in one of the blocks in particular.

International patent application WO 2006/075 328 describes compounds of diarylalkylene type that may serve for optical storage.

International patent application WO 2006/075 327 describes polymers containing chromophores of diarylalkylene type. Mention is made of a “cooperative effect” when the chromophore concentration increases.

International patent application WO 2006/075 329 describes a 3D memory in disk form.

### BRIEF DESCRIPTION OF THE INVENTION

The invention relates to a block copolymer comprising:
at least one soft block A with a T_{g} of between −55° C. and 0° C. and preferably between −40° C. and −1° C.,
at least one block B comprising at least one photoactive monomer bearing a photoisomerizable chromophore.

According to the invention, at least one soft block A or at least one block B means that the block copolymer may comprise one or more blocks A and one or more blocks B.

In addition, block B may comprise one or more photoactive monomers combined with another monomer. In particular, in addition to the photoactive monomer, block B may advantageously comprise a monomer with a cooperative effect.

The photoactive monomer has the formula (I):

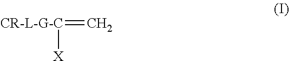

in which:
X denotes H or CH₃—;
G denotes —O—C(═O)—, —C(═O)—O—, a phenyl group, which may or may not be substituted with one or more substituents, or alternatively —NR—C(═O)—, NR being linked to L and R being H or a C₁-C₁₀ alkyl group;
L denotes a spacer group;
CR denotes a photoisomerizable chromophore.

The block copolymer allows a 3D optical memory to be obtained. The invention also relates to the mixture comprising the block copolymer and a polymer that is a thermoplastic, a thermoplastic elastomer or a thermosetting polymer, and also to a 3D optical memory comprising the block copolymer or the polymer blend. A subject of the invention is also the use of a block copolymer or of a blend of block copolymers as described previously for achieving optical data storage.

### DETAILED DESCRIPTION

T_{g} denotes the glass transition temperature of a polymer, measured by DSC according to ASTM E1356. Mention is also made of the T_{g} of a monomer to denote the T_{g} of the homopolymer with a number-average molecular mass Mₙ of at least 10 000 g/mol, obtained by radical polymerization of said monomer. Thus, it will be stated that ethyl acrylate has a T_{g} of −24° C. since homopolyethyl acrylate has a T_{g} of −24° C. All the percentages are given on a weight basis, unless otherwise mentioned.

The term photoactive monomer means a monomer bearing a photoisomerizable chromophoric group CR. The chromophore exists in two isomeric forms, for example cis/trans. Conversion of one form into the other is performed via the action of a light irradiation of suitable wavelength.

According to the invention, the photoactive monomer has the formula (I):

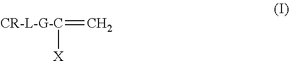

in which:
X denotes H or CH₃—;
G denotes —O—C(═O)—, —C(═O)—O—, a phenyl group, which may or may not be substituted with one or more substituents, or alternatively —NR—C(═O)—, NR being linked to L and R being H or a C₁-C₁₀ alkyl group;
L denotes a spacer group;
CR denotes a photoisomerizable chromophore.

The spacer group L has the function of improving the freedom of movement of the chromophore relative to the copolymer chain so as to promote the conversion of the chromophore from one form to the other. This improves the readability and the speed of reading. Preferably, L is chosen such that G and CR are connected together via a sequence of 2 or more atoms which are linked together via covalent bonds. L may be chosen, for example, from groups (CR₁R₂)ₘ, O(CR₁R₂)ₘ, (OCR₁R₂)ₘ or (SCR₁R₂)ₘ in which m is an integer greater than 2 and preferably between 2 and 10, and R₁ and R₂ independently denote H, halogen or alkyl or aryl groups. Preferably, R₁ and R₂ denote H.

The chromophore CR is preferably of the diarylalkylene type existing in cis and trans isomeric forms. It may also be one of the chromophores disclosed in patent applications WO 01/73779, WO 03/070 689, WO 2006/075 329 or WO 2006/075 327. Preferably, the chromophore CR is chosen such that the isomerization energy barrier is greater than 80 kJ/mol. Specifically, it is desirable for the isomerization to be a very slow process at room temperature to prevent loss of the recorded data.

Preferably, the photoactive monomer has the formula (II):

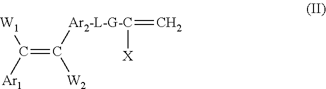

in which:
Ar₁ and Ar₂ denote aryl groups, optionally substituted with one or more substituents;
W₁ and W₂ are chosen from groups H, —CN, —COOH, —COOR′, —OH, —SO₂R′, —NO₂, R′ being a C₁-C₁₀ alkyl or aryl group.

The chromophore corresponds to the group Ar₁W₁C═CW₂Ar₂. L is linked via covalent bonds to Ar₂ and also to G. Ar₁ and Ar₂ denote substituted or unsubstituted aryl groups. They are chosen, for example, independently of each other, from phenyl, biphenyl, anthracene and phenanthrene groups. The optional substituent(s) are chosen from: H, C₁-C₁₀ alkyl, NO₂, halogen or C₁-C₁₀ alkoxy, NR″R□ with R″ and R□ being H or a C₁-C₁₀ alkyl. Ar₁ is attached to the C═C double bond of the chromophore. Ar₂ is attached to the C═C double bond of the chromophore and also to the group L.

Preferably, G is —O—C(═O)— or the phenyl group C₆H₄, i.e. the photoactive monomer has the formula:

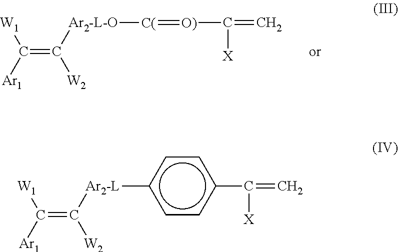

Preferably, Ar₁ is a phenyl or biphenyl group and Ar₂ is a phenyl or biphenyl group, each of the phenyl and/or biphenyl groups possibly being substituted with one or more substituents, i.e. the chromophore has the formula (V) or (VI):

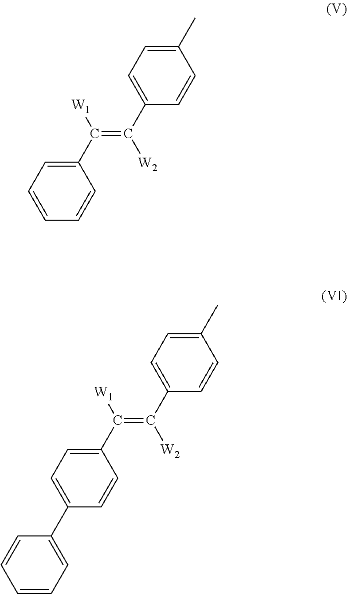

The optional substituent(s) may be, for example, H, aryl, C₁-C₁₀ alkyl, NO₂, halogen or C₁-C₁₀ alkoxy.

According to one preferred form, W₁ and W₂ denote H or CN, Ar₂ is a phenyl or biphenyl group, Ar₁ is a phenyl or biphenyl group substituted in the para position with R₅O— or R₅S—. R₅ denotes a substituted or unsubstituted alkyl or aryl group. Preferably, R₅ is a C₁-C₄ alkyl group. R₅ may be, for example, a methyl, ethyl, propyl or butyl group. For example, it may be a chromophore of formula (VII):

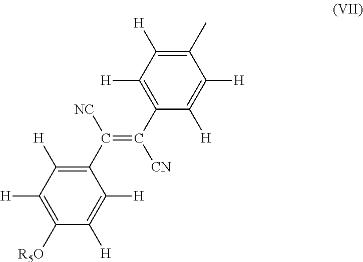

According to another preferred form, W₁ and W₂ denote H or CN, Ar₂ is a phenyl or biphenyl group, Ar₁ is a biphenyl group substituted in the para position with R₅O— or R₅S—. For example, it may be the chromophore of formula (VIII):

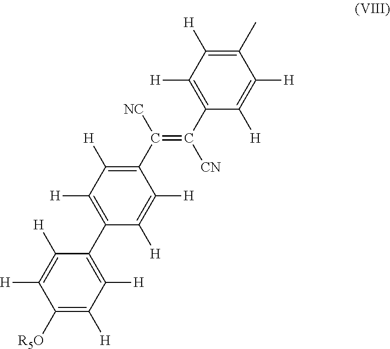

The following two monomers noted MeAA or MeMMA are most particularly preferred:

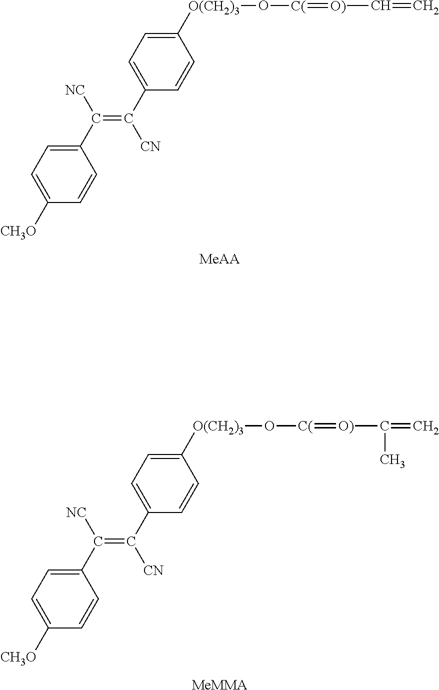

Specifically, they have good optical characteristics for writing and reading (see in this respect Japan Journal of Applied Physics Vol. 45, No. 28, 2006, pp. 1229-1234):
the trans isomer has greater fluorescence than the cis isomer;
the trans isomer has a large effective cross section for biphotonic absorption;
the Stokes shift is greater than 100 nm (little overlap between the absorption spectrum and the emission spectrum, with respective peaks at about 375 and 485 nm).

They are more easily copolymerizable with a large range of monomers, in particular via the controlled radical polymerization technique. Finally, they show great stability since the isomerization energy barrier is greater than 80 kJ/mol.

Chromophores that have low overlap, i.e. <35% or even better still <20%, between the absorption and emission spectra are preferred (see in this respect page 22 of WO 2006/075 327). This makes it possible to increase the chromophore concentration and thus to promote the cooperative effect without harming the signal quality during reading. The overlap depends both on the Stokes shift and on the peak width. The overlap is defined as being the percentage of emission absorbed for a 0.01 M solution of the chromophore in a cuvette with a 1 cm optical path length. Preferably, the Stokes shift is >100 nm. Measurement of the Stokes shift is well known to those skilled in the art: reference may be made especially to the document Dekker encyclopedia of nanoscience and nanotechnology by James A. Schwartz et al., edition: illustrated published by CRC Press, 2004, pages 4014 et seq. or the Encyclopedia of Optical Engineering: Las-Pho, pages 1025 et seq., by Ronald G. Driggers, edition illustrated published by CRC Press, 2003. This shift is measured by comparing the emission and absorption spectra of the chromophore in a commercial spectrofluorimeter. This shift represents a physical property of a chromophore and is independent of the type of spectrofluorimeter used.

The invention is not limited to the particular chromophores of diarylalkylene type, but may also apply to other photoisomerizable chromophores, comprising, for example, stilbene, spiropyran, azobenzene, bisazobenzene, trisazobenzene or azoxybenzene groups. A list of chromophores that may be used in the invention is found in the following documents: U.S. Pat. No. 5,023,859, U.S. Pat. No. 6,875,833 and U.S. Pat. No. 6,641,889.

The term monomer with a cooperative effect means a compound of formula (VIII):

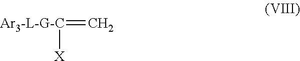

in which:
X, G and L have the same meanings as for the photoactive monomer;
Ar₃ denotes an aromatic group that may or may not be substituted with one or more substituents.

This monomer with a cooperative effect interacts with the chromophore and/or improves the cooperative effect between the chromophores themselves, which improves the speed of writing. An interpretation of the cooperative effect is that the monomer modifies the microenvironment of the chromophore and promotes the photoisomerization.

The substituent for formula (VIII) is chosen from:
(i) halogens;
(ii) —COOY, —CONYY′, —OY, —SY or —C(═O)Y, Y and Y′ denoting a group H or C₁-C₁₀ alkyl;
(iii) —CYY′Y″, Y, Y′ and Y″ denoting a group H or C₁-C₁₀ alkyl.

Advantageously, Ar₃ is a phenyl group. Advantageously, the halogen group is chlorine. Even more advantageously, Ar₃ is chosen from the following groups:

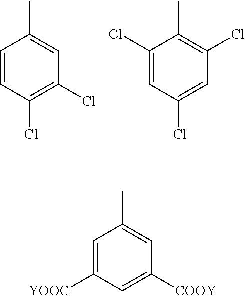

By way of example, the following hindered monomers may be used:

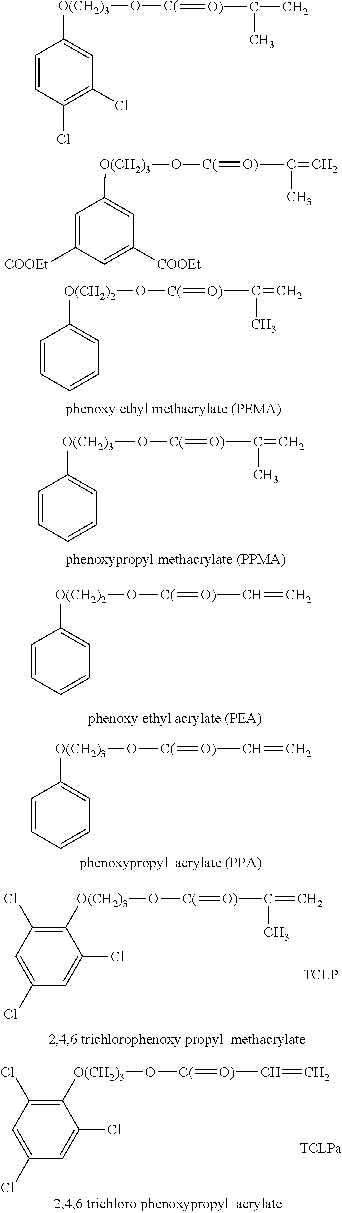

As regards block A, it may be “rigid” or “soft”. It is considered that block A is “rigid” when its glass transition temperature is greater than room temperature, 25° C. It is considered that block A is “soft” when its glass transition temperature is less than 25° C. It has according to the invention a T_{g} of between −55° C. and 0° C. and preferably between −40° C. and −1° C., and is therefore soft. Preferably, it also has a number-average mass Mn>1000 g/mol, advantageously >5000 g/mol and preferably >10 000 g/mol.

One of the functions of the soft block A is to obtain sufficient mechanical strength of the memory-storage material.

The soft block A is obtained from the polymerization of at least one vinyl, vinylidene, diene, olefin, allylic or (meth)acrylic monomer such that the combination of monomers leads to a Tg of block A<20° C. and in particular not more than 0° C., for example between −30° C. and −3° C. These monomers are chosen more particularly from vinyl aromatic monomers such as styrene or substituted styrenes, especially α-methylstyrene, acrylic monomers such as acrylic acid or salts thereof, alkyl, cycloalkyl or aryl acrylates such as methyl, ethyl, butyl, ethylhexyl or phenyl acrylate, hydroxyalkyl acrylates such as 2-hydroxyethyl acrylate, alkyl ether acrylates such as 2-methoxyethyl acrylate, alkoxy- or aryloxy-polyalkylene glycol acrylates such as methoxypolyethylene glycol acrylates, ethoxypoly-ethylene glycol acrylates, methoxypolypropylene glycol acrylates, methoxypolyethylene glycol-polypropylene glycol acrylates or mixtures thereof, aminoalkyl acrylates such as 2-(dimethylamino)ethyl acrylate (DAMEA), fluoroacrylates, silylacrylates, phosphoric acrylates such as alkylene glycol phosphate acrylates, methacrylic monomers such as methacrylic acid or salts thereof, alkyl, cycloalkyl, alkenyl or aryl methacrylates such as methyl methacrylate (MMA), lauryl, cyclohexyl, allyl, phenyl or naphthyl methacrylate, hydroxyalkyl methacrylates such as 2-hydroxyethyl methacrylate or 2-hydroxypropyl methacrylate, alkyl ether methacrylates such as 2-ethoxyethyl methacrylate, alkoxy- or aryloxypolyalkylene glycol methacrylates such as methoxypolyethylene glycol methacrylates, ethoxypolyethylene glycol methacrylates, methoxypolypropylene glycol methacrylates, methoxypolyethylene glycol-polypropylene glycol methacrylates or mixtures thereof, aminoalkyl methacrylates such as 2-(dimethylamino)ethyl methacrylate (DAMEMA), fluoromethacrylates such as 2,2,2-trifluoroethyl methacrylate, silyl methacrylates such as 3-methacryloylpropyltrimethylsilane, phosphoric methacrylates such as alkylene glycol phosphate methacrylates, hydroxyethylimidazolidone methacrylate, hydroxyethylimidazolidinone methacrylate, 2-(2-oxo-1-imidazolidinyl)ethyl methacrylate, acrylonitrile, acrylamide or substituted acrylamides, 4-acryloyl-morpholine, N-methylolacrylamide, methacrylamide or substituted methacrylamides, N-methylolmethacrylamide, methacrylamidopropyltrimethylammonium chloride (MAPTAC), itaconic acid, maleic acid or salts thereof, maleic anhydride, alkyl or alkoxy- or aryloxypolyalkylene glycol maleates or hemimaleates, vinylpyridine, vinylpyrrolidinone, (alkoxy)poly-(alkylene glycol)vinyl ether or divinyl ether, such as methoxypoly(ethylene glycol) vinyl ether, poly(ethylene glycol)divinyl ether, olefin monomers, among which mention may be made of ethylene, butene, hexene and 1-octene and also fluoroolefin monomers, and vinylidene monomers, among which mention may be made of vinylidene fluoride, alone or as a mixture of at least two abovementioned monomers.

The soft block A is preferably obtained from styrene and/or from (meth)acrylic and/or alkyl acrylate monomer(s). Advantageously, block A comprises as predominant monomer(s) styrene and/or MMA and/or butyl acrylate or 2-ethylhexyl acrylate. Preferably, it comprises at least 50% of butyl acrylate or of 2-ethylhexyl acrylate.

Block A is intended to give the mechanical strength and/or rigidity properties of the finished material.

According to the process for preparing the block copolymer, the soft block A may contain, in addition to the above monomers, monomer(s) composing the block(s) B, especially the photoactive monomer or the monomer with a cooperative effect. Specifically, when block B is prepared during a first step, block A may contain residues of the constituent monomer(s) of block B. Thus, if this (these) residual monomer(s) that has (have) not been fully polymerized are present in the reaction mixture when the polymerization leading to the block(s) A begins, the block(s) A may comprise monomer(s) initially introduced to prepare the block(s) B. Thus, for example, the soft block A may comprise, on a weight basis, from 40% to 100% of styrene and/or of butyl or 2-ethylhexyl acrylate, from 0 to 30% of at least one comonomer chosen from the list defined previously and from 1% to 30% of at least one photoactive monomer, the total making 100%.

As regards block B, it comprises at least one photoactive monomer and optionally at least one other monomer that is copolymerizable with the photoactive monomer. Said other monomer may be chosen from the list of monomers defined previously for block A. It may also be a monomer with a cooperative effect. The weight content of photoactive monomer in block B may range from 5% to 100%.

According to one preferred form, the monomer that is copolymerized with the photoactive monomer is a monomer with a cooperative effect. It is preferably TCLP, PEMA, TCLPa or PEA. Block B comprises, for example, on a weight basis, from 10% to 80% of at least one photoactive monomer, from 10% to 80% of at least one monomer with a cooperative effect and optionally one or more other comonomers chosen from the preceding list (the total making 100%).

According to the process for preparing the block copolymer, block B may contain monomer(s) composing the block(s) A. Specifically, when block A is prepared during a first step, block B may contain residues of monomers constituting block A. Thus, if these residual monomers that have not been fully polymerized are present in the reaction mixture when the polymerization leading to the block(s) B begins, the block(s) B may comprise monomer(s) initially introduced to prepare the block(s) A. Thus, for example, block B may comprise, on a weight basis, from 40% to 100% of active monomer and/or monomer with a cooperative effect, from 0 to 60% of at least one monomer chosen from the list defined previously for the synthesis of block A, the total making 100%.

As regards the block copolymer of the invention, it comprises at least one soft block A and at least one block B comprising at least one photoactive monomer.

According to the definition given in 1996 by the IUPAC in its recommendations on polymer nomenclature, a block copolymer is formed from adjacent blocks that are constitutionally different, i.e. blocks comprising units derived from different monomers or from the same monomer, but with a different composition or sequential distribution of the units. A block copolymer may be, for example, a diblock, triblock or star copolymer.

Preferably, the block copolymer is such that the block(s) A and the block(s) B are incompatible, i.e. they have a Flory-Huggins interaction parameter ₓ_{^{AB}}>0 at room temperature (this parameter is well known to those skilled in the art and is described especially in the publication Chimie et physico-chimie des polymères, by M. Fontanille and Y. Gnanou, Dunod, 2002). This leads to a phase microseparation with formation of a two-phase structure at the macroscopic scale. The block copolymer is then nanostructured, i.e. domains with a size of less than 100 nm and preferably between 5 and 50 nm are formed. Nanostructuring has the advantage of leading to a transparent material. Furthermore, this makes it possible to obtain domains concentrated with chromophores since there is no “dilution” with the block(s) A, which makes it possible to promote the cooperative effect between chromophores (with increase of the writing speed).

The block copolymer is preferably a triblock copolymer B-A-B′ comprising a central block A linked via covalent bonds to two side blocks B and B′ (i.e. arranged on each side of the central block A). B and B′ may be identical or different (this type of copolymer is also occasionally noted B-b-A-b-B′). It may also be a triblock copolymer A-B-A′ comprising a central block B linked via covalent bonds to two side blocks A and A′ (i.e. arranged on each side of the central block B) and which comprise chromophoric units. A and A′ may be identical or different.

However, according to the process used for the synthesis of the block copolymer, more complex structures may be obtained, for example with a number of blocks greater than or equal to 2, for example 5 blocks, B″-A′-B′-A-B, 6 blocks, etc. The block copolymer synthesized may thus be formed from a single structure or from a mixture of different structures, which are more or less complex. The mechanical and optical properties obtained may then vary widely according to the block copolymer used in the 3D memory storage material. However, the nanometric structuring obtained by the incompatibility of blocks A and B remains a common feature of the various block copolymers that form the subject of the present invention.

Among the triblock copolymers ABA′ or BAB′ that may be used in the invention, mention may be made more particularly of those for which:
the blocks A and A′ comprise as predominant monomer(s) styrene and/or MMA and/or alkyl acrylate;
the blocks B and B′ comprise, on a weight basis, from 10% to 60% of at least one photoactive monomer, from 10% to 60% of at least one monomer with a cooperative effect and optionally a monomer from the preceding list of monomers mentioned for block A (the total making 100%), which is preferably an alkyl (meth)acrylate, more particularly methyl methacrylate.

The block copolymer may be used alone or as a blend with another polymer of sufficient transparency in the wavelength range used for writing or reading, and also with low birefringence. It may be a thermoplastic, a thermoplastic elastomer or a thermosetting polymer. This characteristic is important for the 3D optical memory technology for which it is necessary for the light ray to reach each of the layers of the memory without being perturbed. A thermoplastic such as a methyl methacrylate or styrene or alternatively a polycarbonate homopolymer or copolymer is preferably used. The blend comprises, on a weight basis, from 50% to 100%, advantageously from 75% to 100% and preferably from 90% to 100% of the block copolymer per, respectively, 0 to 50%, advantageously 0 to 25% and preferably 5% to 10% of the thermoplastic. The blend is obtained via any thermoplastic blending technique known to those skilled in the art. It is preferably obtained by extrusion. The block copolymer and/or the blend of block copolymers may also optionally comprise various additives (antistatic, lubricant, coloring, plasticizing, antioxidant, UV-stabilizing, etc. agents).

Process for Obtaining the Block Copolymer

The block copolymer is obtained via the polymerization techniques known to those skilled in the art. One of these polymerization techniques may be anionic polymerization as taught, for example, in the following documents: FR 2 762 604, FR 2 761 997 and FR 2 761 995. It may also be the controlled radical polymerization technique, which comprises several variants depending on the nature of the control agent used. Mention may be made of SFRP (Stable Free Radical Polymerization) which uses nitroxides as control agent and may be initiated with alkoxyamines, ATRP (Atom Transfer Radical Polymerization) which uses metal complexes as control agent and is initiated with halogenated agents, RAFT (Reversible Addition Fragmentation Transfer), which involves sulfur products such as dithioesters, trithiocarbonates, xanthates or dithiocarbamates. Reference may be made to the general review by Matyjaszewski, K. (Ed.), ACS Symposium Series (2003), 854 (Advances in Controlled/Living Radical Polymerization) and also to the following documents for further details regarding the controlled radical techniques that may be used: FR 2 825 365, FR 2 863 618, FR 2 802 208, FR 2 812 293, FR 2 752 238, FR 2 752 845, U.S. Pat. No. 5,763,548 and U.S. Pat. No. 5,789,487.

Controlled radical polymerization with a control via nitroxides T is the preferred technique for obtaining the block copolymer of the invention. Specifically, this technique does not need to be performed under conditions as harsh as those for anionic polymerization (i.e. absence of moisture, temperature<100° C.). It also allows polymerization of a wide range of monomers. It may be performed under varied conditions, for example in terms of mass, solvent or dispersed medium such as suspension or emulsion in water.

Nitroxide T is a stable free radical containing a group ═N—O., i.e. a group on which a free electron is present. The term “stable free radical” denotes a radical that is so persistent and unreactive toward air and atmospheric moisture that it can be manipulated and stored for a much longer time than the majority of free radicals (see in this respect Accounts of Chemical Research, 1976, 9, 13-19). The stable free radical thus differs from free radicals whose lifetime is short (from a few milliseconds to a few seconds) such as the free radicals derived from the usual polymerization initiators, for instance peroxides, hydroperoxides or azo initiators. Polymerization-initiating free radicals tend to accelerate the polymerization, whereas stable free radicals generally tend to slow it down. It may be said that a free radical is stable within the meaning of the present invention if it is not a polymerization initiator and if, under the usual conditions of the invention, the average lifetime of the radical is at least one minute.

The nitroxide T is represented by structure (IX):

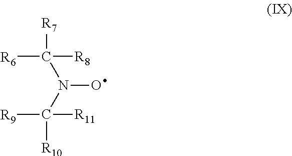

in which R₆, R₇, R₈, R₉, R₁₀ and R₁₁ denote linear or branched C₁-C₂₀ and preferably C₁-C₁₀ alkyl groups such as methyl, ethyl, propyl, butyl, isopropyl, isobutyl, tert-butyl or neopentyl, which may be substituted or unsubstituted, C₆-C₃₀ aryls, optionally substituted with one or more substituents, such as benzyl, aryl (phenyl), and saturated C₁-C₃₀ cyclic groups, and in which the groups R₆ and R₉ may form part of an optionally substituted cyclic structure R₆—CNC—R₉ that may be chosen from:

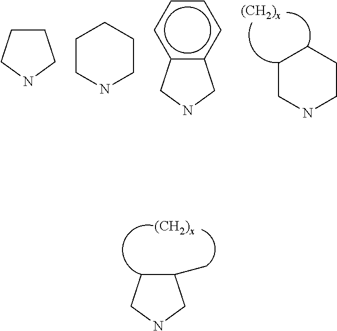

x denoting an integer between 1 and 12.

By way of example, the following nitroxides may be used:

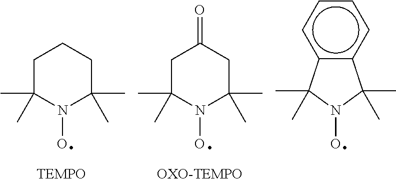

In a particularly preferred manner, the nitroxides of formula (X) are used in the context of the invention:

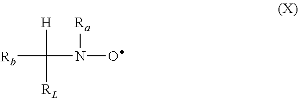

Rₐ and R_{b} denote identical or different alkyl groups containing from 1 to 40 carbon atoms, optionally connected together so as to form a ring and optionally substituted with hydroxyl, alkoxy or amino groups,
R_{L} denotes a monovalent group with a molar mass of greater than 16 g/mol and preferably greater than 30 g/mol. The group R_{L} may have, for example, a molar mass of between 40 and 450 g/mol. It is preferably a phosphoric group of general formula (XI):

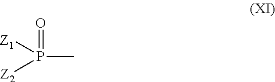

in which Z₁ and Z₂, which may be identical or different, may be chosen from alkyl, cycloalkyl, alkoxy, aryloxy, aryl, aralkyloxy, perfluoroalkyl and aralkyl radicals and may comprise from 1 to 20 carbon atoms; Z₁ and/or Z₂ may also be a halogen atom such as a chlorine, bromine or fluorine atom.

Advantageously, R_{L} is a phosphonate group of formula:

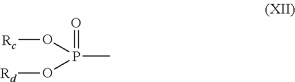

in which R_{c} and R_{d} are two identical or different alkyl groups, optionally linked so as to form a ring, comprising from 1 to 40 carbon atoms, optionally substituted with one or more substituents as described previously.

In particular, the stable nitroxide radical is derived from a molecule that can split into two radicals, one a nitroxide, which regulates the polymerization, and the other a polymerization initiator. As molecule capable of forming in situ the stable nitroxide radical under the effect of a temperature rise, mention may be made of Blocbuilder® manufactured and sold by the Applicant.

The group R_{L} may also comprise at least one aromatic ring such as a phenyl radical or a naphthyl radical, for example substituted with one or more alkyl radicals comprising from 1 to 10 carbon atoms.

The nitroxides of formula (X) are preferred since they afford good control of the radical polymerization of (meth)acrylic monomers. The alkoxyamines of formula (XIII) are preferred:

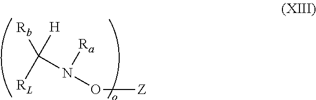

in which Z denotes a multivalent group and o denotes an integer between 1 and 10 (limits included). Z is a group capable of releasing several radical sites after thermal activation and cleavage of the covalent bond Z-T. Examples of groups Z are found on pages 15 to 18 of international patent application WO 2006/061 523. Preferably, Z is a divalent group, i.e. the integer o is 2.

To obtain a triblock copolymer using the controlled radical polymerization technique, it is advantageously possible to use a difunctional alkoxyamine of formula T-Z-T (i.e. an alkoxyamine of formula (XIII) with o=2). The process begins with preparation of the central block by polymerizing, using the alkoxyamine, the monomer blend leading to the central block. The polymerization takes place with or without solvent, or alternatively in dispersed medium. The mixture is heated to a temperature above the activation temperature of the alkoxyamine. When the central block is obtained, the monomer(s) leading to the side blocks is (are) added. It may be that after the preparation of the central block, monomers that have not been entirely consumed remain, which may be optionally chosen to be removed before the preparation of the side blocks. The removal may consist, for example, in precipitating in a nonsolvent, recovering and drying the central block. If it is chosen not to remove the monomers that have not been entirely consumed, they may polymerize with the monomers introduced to prepare the side blocks.

Data Writing/Reading

The optical principles underlying the present invention are the same as those described in international patent applications WO 01/73779 and WO 03/070 689.

The writing is based on the conversion of one isomeric form into another under the effect of a light irradiation. The conversion makes it necessary to have a chromophore in an excited state, which necessitates absorption to an energy level E. The absorption of two photons is facilitated by combining the energy of at least two photons of one or more light beams of different energy levels E₁ and E₂ that may be different from E. The two light beams are in the UV, visible or near infrared range. Preferably, only one light beam is used and the conversion is the result of a process of absorption of two photons.

Reading may be based on a process of linear or nonlinear electron excitation. The emission spectra of the two isomers are different and the emission is collected using a suitable reading device. A nonlinear process such as Raman dispersion or a four-wave mixing process may be used.

A small volume element of the 3D memory contains the chromophores in one predominant isomeric form or in the other. The volume element thus contains the stored information in a well defined and localized area of the memory and is characterized by an optical signal different from that of its immediate environment.

As Regards the 3D Optical Memory

The invention also relates to the 3D optical memory (or 3D optical storage unit) comprising the block copolymer or the blend of block copolymers of the invention and which is used for recording (storing) data. A 3D memory is a memory that can store data at any point (defined by three coordinates x, y and z) of the volume of the memory. A 3D memory allows data storage in several virtual layers (or virtual levels). The volume of the 3D memory is thus linked to the physical volume that it occupies.

This memory is in the form, for example, of a square or rectangular plate, a cube or a disk that comprises the block copolymer of the invention optionally in the form of the blend as described previously. The 3D memory may be obtained by injecting the block copolymer or the blend of block polymers. This conversion technique is known to polymer chemists and consists in injecting the molten material under pressure into a mold (in this respect, reference may be made to the Précis de matières plastiques, Nathan, 4^{th} edition, ISBN 2-12-355352-2, pp. 141-156). The material is melted and compressed using an extruder. Several layers comprising the block copolymer or the blend of block copolymers of the invention may also be superposed, as taught in international patent application WO 2006/075 329.

Preferably, the 3D optical memory is in the form of a disk, which allows it to be rotated, the writing or reading head being stationary. The disk may be obtained by injection or molding of the block copolymer or of the blend of block copolymers if the latter has the appropriate mechanical characteristics. It may also be obtained by depositing the block copolymer or the blend of copolymers onto a rigid support that is transparent in the wavelength range used for the writing and/or reading.

### EXAMPLES

Blocbuilder® corresponds to the product of formula:

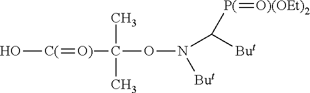

### Example 0

### Preparation of a Difunctional Dialkoxyamine

125 ml of ethanol, 38 g of Blocbuilder® and 10 g of 1,4-butanediol diacrylate are placed in a 250 cm³ glass reactor made inert by flushing with nitrogen. The reaction mixture is maintained at 80° C. for 4 hours with stirring (250 rpm). The resulting mixture is then cooled and the ethanol is evaporated off under vacuum. The resulting solid is formed from a dialkoxyamine, which is then used without further processing.

### Example 1

### Preparation of a P(MeMMA co PEMA)-b-P(butyl acrylate co styrene)-b-P(MeMMA co PEMA) triblock copolymer

Step 1: Synthesis of the Soft Block A

98.6 g of dialkoxyamine of Example 0, 660 g of styrene and 1540 g of butyl acrylate are placed, under an inert atmosphere, in a 3-liter stainless-steel reactor with stirring. The reaction is performed at 118° C. for 190 minutes.

The resulting reaction product is treated to remove the unreacted monomers.

The polybutyl acrylate co styrene obtained is then removed from the reactor.

The measured Tg of block A is −5° C.

Step 2: Synthesis of Block B

45 g of block A, 105 g of MeMMA, 105 g of PEMA and 1200 g of toluene are placed in a 3-liter reactor.

The reaction is performed at 116° C. with stirring for 3 hours.

The reaction product is then removed. It corresponds to the expected triblock polymer.

### Example 2

Step 1: Synthesis of the Soft Block A

98.6 g of dialkoxyamine of Example 0, 660 g of styrene and 1540 g of butyl acrylate are placed, under an inert atmosphere, in a 3-liter stainless-steel reactor with stirring.

The reaction is performed at 118° C. for 190 minutes.

The resulting reaction product is treated to remove the unreacted monomers.

The polybutyl acrylate co styrene obtained is then removed from the reactor.

The measured Tg of block A is −5° C.

Step 2: Synthesis of Block B

60 g of block A, 240 g of MeMMA, 240 g of PEMA and 880 g of toluene are placed in a 3-liter reactor.

The reaction is performed at 116° C. with stirring for 3 hours.

The reaction product is then removed. It corresponds to the expected triblock copolymer.

### Example 3

### Preparation of a P(MeMMA co PEMA)-b-P(butyl acrylate co styrene) diblock copolymer

Step 1: Synthesis of the Soft Block A

70 g of Blocbuilder®, 630 g of styrene and 1470 g of butyl acrylate are placed, under an inert atmosphere, in a 3-liter stainless-steel reactor with stirring.

The reaction is performed at 117° C. for 180 minutes.

The resulting reaction product is treated to remove the unreacted monomers.

The polybutyl acrylate co styrene obtained is then removed from the reactor.

The measured Ty of block A is −5° C.

Step 2

20 g of block A, 80 g of MeMMA, 80 g of PEMA and 1100 g of toluene are placed in a 3-liter reactor.

The reaction is performed at 116° C. with stirring for 3 hours.

The reaction product is then removed. It corresponds to the expected diblock copolymer.

### Example 4

### Production of a Disk

The polymer solutions, obtained in Examples 1 to 3, are precipitated in a large amount of methanol at room temperature, filtered, washed and then dried. The product obtained is then formed by compression-molding at 150° C. for 10 minutes to form a disk 2 cm in diameter and 2 mm thick. The light transmission is greater than 80% over the entire visible range.

This disk is then subjected to a static data reading-writing test using a suitable laser device. Recording of data on the disk was observed.

1. A block copolymer comprising:
at least one soft block A with a T_{g} of between −55° C. and 0° C. and preferably between −40° C. and −1° C., and
at least one block B comprising at least one photoactive monomer bearing a photoisomerizable chromophore of formula (I): 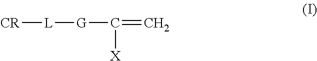
in which:
X denotes H or CH₃—;
G denotes —O—C(═O)—, —C(═O)—O—, a phenyl group, which may or may not be substituted, or alternatively —NR—C(═O)—, NR being linked to L and R being H or a C₁-C₁₀ alkyl group;
L denotes a spacer group;
CR denotes a photoisomerizable chromophore.

2. The block copolymer as claimed in claim 1, characterized in that the spacer group L is chosen such that G and CR are connected together via a sequence of 2 or more atoms that are linked together via covalent bonds.

3. The block copolymer as claimed in either of the preceding claims, characterized in that L is chosen from (CR₁R₂)ₘ, O(CR₁R₂)ₘ, (OCR₁R₂)ₘ and (SCR₁R₂)ₘ in which m is an integer greater than 2 and preferably between 2 and 10, R₁ and R₂ independently denote H, halogen or alkyl or aryl groups.

4. The block copolymer as claimed in one of the preceding claims, characterized in that the chromophore CR is of the diarylalkylene type.

5. The block copolymer as claimed in one of the preceding claims, characterized in that the chromophore CR has an overlap<35%, the spectra being recorded on a 0.01 M solution of the chromophore in a cuvette with a 1 cm optical path length.

6. The block copolymer as claimed in one of the preceding claims, characterized in that the Stokes shift is >100 nm.

7. The block copolymer as claimed in one of the preceding claims, characterized in that the photoactive monomer has the formula (II): 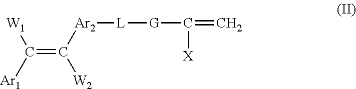
in which:
Ar₁ and Ar₂ denote optionally substituted aryl groups;
W₁ and W₂ are chosen from groups H, —CN, —COOH, —COOR′, —OH, —SO₂R′ and —NO₂, R′ being a C₁-C₁₀ alkyl or aryl group.

8. The block copolymer as claimed in claim 7, characterized in that Ar₁ and Ar₂ are chosen, independently of each other, from substituted or unsubstituted phenyl, biphenyl, anthracene and phenanthrene groups.

9. The block copolymer as claimed in claim 7, characterized in that the photoactive monomer has the formula (III) or (IV): 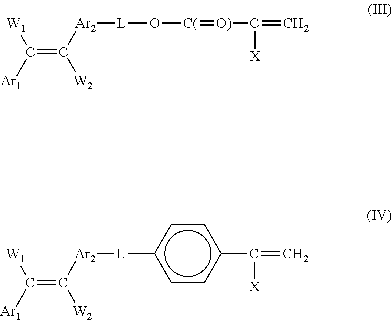
in which:
Ar₁ and Ar₂ denote optionally substituted aryl groups;
W₁ and W₂ are chosen from groups H, —CN, —COOH, —COOR′, —OH, —SO₂R′ and —NO₂, R′ being a C₁-C₁₀ alkyl or aryl group.

10. The block copolymer as claimed in any one of the preceding claims, in which the chromophore is chosen from: 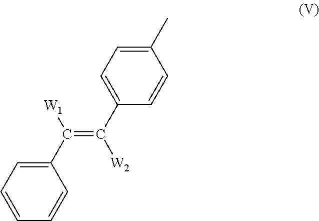
W₁ and W₂ being chosen from groups H, —CN, —COOH, —COOR′, —OH, —SO₂R′ and —NO₂, R′ being a C₁-C₁₀ alkyl or aryl group and each of the two phenyl rings being optionally substituted.

11. The block copolymer as claimed in claim 10, characterized in that Ar₁ is a phenyl or biphenyl group and Ar₂ is a phenyl or biphenyl group, each of the phenyl and/or biphenyl groups optionally being substituted.

12. The block copolymer as claimed in claim 11, characterized in that W₁ and W₂ denote CN, Ar₂ is a phenyl or biphenyl group, Ar₁ is a phenyl or biphenyl group or a biphenyl group substituted in the para position with R₅O—, R₅S—, R₅ denoting a substituted or unsubstituted alkyl or aryl group.

13. The block copolymer as claimed in claim 7, characterized in that the photoactive monomer is MeAA or MeMMA of formulae:

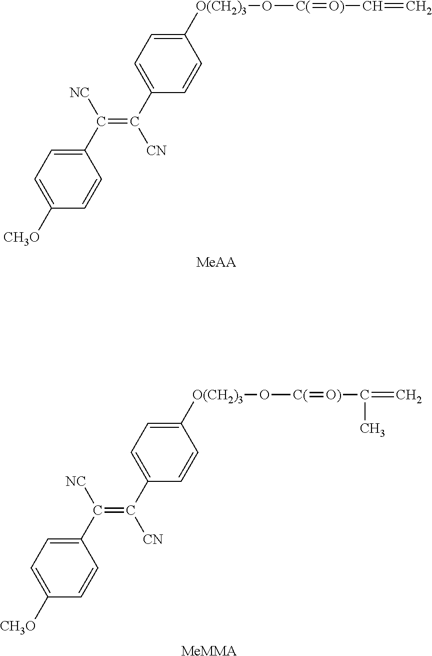

14. The block copolymer as claimed in any one of claims 1 to 4, characterized in that the chromophore CR comprises a stilbene, spiropyran, azobenzene, bisazobenzene, trisazobenzene or azoxybenzene group.

15. The block copolymer as claimed in any one of the preceding claims, characterized in that block A has a number-average mass Mₙ>2000 g/mol, advantageously >5000 g/mol, preferably >10 000 g/mol and even more preferentially >50 000 g/mol.

16. The block copolymer as claimed in either of the preceding two claims, characterized in that the Tg of block A is between −30° C. and −3° C.

17. The block copolymer as claimed in one of the preceding claims, characterized in that the soft block A is obtained from the polymerization of at least one vinyl, vinylidene, diene, olefin, allylic or (meth)acrylic monomer.

18. The block copolymer as claimed in claim 16, characterized in that block A comprises as predominant monomer(s) butyl or 2-ethylhexyl acrylate.

19. The block copolymer as claimed in one of the preceding claims, characterized in that block B comprises at least one photoactive monomer and optionally at least one other monomer that is copolymerizable with the photoactive monomer.

20. The block copolymer as claimed in one of claims 17 to 19, characterized in that block B also comprises a monomer with a cooperative effect of formula (IX): 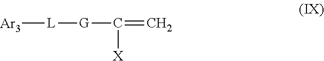
in which:
X, G and L are as defined in any one of claims 2 to 4;
Ar₃ denotes an aromatic group optionally substituted with one or more substituents.

21. The block copolymer as claimed in claim 20, characterized in that the substituent is chosen from:
(i) halogens, preferably chlorine;
(ii) —COOY, —CONYY′, —OY, —SY or —C(═O)Y, Y and Y′ denoting a group H or C₁-C₁₀ alkyl;
(iii) —CYY′Y″, Y, Y′ and Y″ denoting a group H or C₁-C₁₀ alkyl.

22. The block copolymer as claimed in either of claims 20 and 21, characterized in that Ar₃ is a phenyl group.

23. The block copolymer as claimed in claim 20, characterized in that the monomer with a cooperative effect is chosen from:

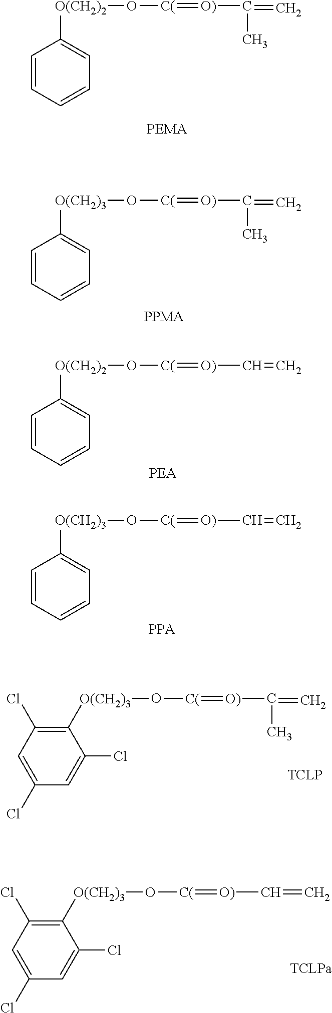

24. The block copolymer as claimed in one of claims 20 to 25, characterized in that block B comprises, on a weight basis, from 10% to 80% of at least one photoactive monomer, from 10% to 80% of at least one monomer with a cooperative effect and optionally one or more other monomers.

25. A blend of a block copolymer as defined in any one of the preceding claims and of a polymer that is a thermoplastic, a thermoplastic elastomer or a thermosetting polymer.

26. The blend as claimed in claim 25, comprising, on a weight basis, from 50% to 100%, advantageously from 75% to 100% and preferably from 90% to 100% of the block copolymer per, respectively, 0 to 50%, advantageously 0 to 25% and preferably 5% to 10% of the thermoplastic polymer, of the thermoplastic elastomer or of the thermosetting polymer.

27. The blend as claimed in claim 25 or 26, in which the thermoplastic polymer is a methyl methacrylate homopolymer or copolymer or a polycarbonate.

28. A 3D optical memory comprising a block copolymer as defined in any one of claims 1 to 24 or a blend as defined in any one of claims 25 to 27.

29. The 3D optical memory as claimed in claim 28, which is in the form of a square or rectangular plate, a cube or a disk.

30. The use of a block copolymer as defined in any one of claims 1 to 24 or of a blend as defined in any one of claims 25 to 27, for achieving optical data storage.

31. The use of a block copolymer as defined in any one of claims 1 to 24 or of a blend as defined in any one of claims 25 to 27 as a 3D optical memory.
